(19) United States
(12) Patent Application Publication
(10) Pub. No.: US 2007/0063924 A1
(43) Pub. Date: Mar. 22, 2007

(54) Fuel cell powered wireless network display systems

(76) Inventor: Frank Yau, Redwood City, CA (US)

Correspondence Address: FRANK YAU, 258 NICE COURT, REDWOOD CITY, CA, 94065, US

(21) Appl. No.: 11/519,547

(22) Filed: Sep. 11, 2006

Related U.S. Application Data
(60) Provisional application No. 60/718,426, filed on Sep. 19, 2005.

(51) Int. Cl. G09G 5/00

(52) U.S. Cl. 345/2.3

(57) ABSTRACT

Methods of wireless network display systems powered by fuel cells. Fuel cell powered wireless network display systems consist of one or plurality of wireless networks and the respective plurality of wireless displays powered by fuel cells or micro fuel cells with replenish-able fuel sources.

### RELATED APPLICATIONS

This application claims the priority of U.S. provisional patent application serial number 60/718,426 filed on Sep. 19, 2005.

The present application incorporates herein by reference, the following U.S. application having the same applicant and inventor as the present application: “WIRELESS INTERACTIVE ENTERTAINMENT AND INFORMATION DISPLAY NETWORK SYSTEMS”, filed on Aug. 29, 2005 having application serial number 11/215,757 with claimed priority dated Aug. 30, 2004.

### FIELD OF THE INVENTION

This invention relates to systems for Fuel Cell Powered Wireless Network Display System. Moreover it pertains specifically to such systems for providing efficient portable or fixed power for prolonged operations in wireless network displays without wiring or extended wiring installations or recharging batteries.

### BACKGROUND OF THE INVENTION

Wireless network technology has enabled portable and simplified network systems for individual access of information and entertainment in real time or on-demand. The wireless networks reduce installation efforts compared to wired networks especially in passenger aircraft and trains. However, power wiring and sometimes rechargeable batteries are still required for these portable or fixed wireless display systems. The prior art is cumbersome in installation due to routing of power cabling or charging batteries that also added costs from fabrication, material, labor, equipment, and maintenance. Aside from the physical and financial disadvantages of a wired power system or rechargeable batteries, weight and space as well as power delivery required from wiring are less attractive especially for aircraft installations. Fuel cell power provides effective alternative to wired power systems from a main electrical power source or rechargeable batteries for delivering power to the wireless displays. Fuel cell systems could provide prolonged portable power and easy to refuel for effective electrical power solutions that could extend to providing efficient power to large networks of wireless display systems in any aircraft passenger cabins, train passenger cabins, passenger buses, passenger cars, passenger ferry cabins, concert halls, lecture halls, libraries, campuses, dormitories, auditoriums, stadiums, entertainment facilities, exercise facilities, waiting-rooms, shopping facilities, or even residential communities.

Prior art in power delivery to portable or fixed wireless network display systems are cumbersome. There is a need for Fuel Cell Powered Wireless Network Display Systems.

### SUMMARY OF THE INVENTION

In view of the limitations now present in the prior art, the present invention provides new and useful Fuel Cell Powered Wireless Network Display Systems that are simpler in construction, more universally usable and more versatile in operation than known system of this kind.

The purpose of the present invention is to provide a new Fuel Cell Powered Wireless Network Display Systems that has many novel features not offered by the prior art that result in new Fuel Cell Powered Wireless Network Display Systems which is not apparent, obvious, or suggested, either directly or indirectly by any of the prior art.

The aspect of the invention is a system for efficient power delivery to a group or groups of individual wireless display apparatus for providing efficient portable or fixed power for prolonged operations in wireless network displays without wiring or extended wiring installations or recharging batteries, but not limited to, an aircraft passenger cabin, train passenger cabin, passenger bus, passenger auto, passenger ferry cabin, concert hall, lecture hall, library, campus, dormitory, auditorium, stadium, entertainment facility, exercise facility, waiting-room, shopping facility, or residential community.

The foregoing has outlined, in general, the physical aspects of the invention and is to serve as an aid to better understanding the more complete detailed description in which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to provide Fuel Cell Powered Wireless Network Display Systems that will overcome the deficiencies of the prior art devices.

An object of the present invention is to provide Fuel Cell Powered Wireless Network Display Systems that use fuel cell or micro fuel cell power to provide efficient portable or alternative fixed power for prolonged operations in wireless network displays without wiring or extended wiring installations or recharging batteries.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1 is a pictorial representation of a Fuel Cell Powered Wireless Network Display System with replaceable fuel cell pack apparatus installed in each individual wireless display according to the present invention.

FIG. 2 is a pictorial representation of a Fuel Cell Powered Wireless Network Display System with replaceable fuel cartridge or storage container for the fuel cell apparatus embedded in each individual wireless display according to the present invention.

FIG. 3 is a pictorial representation of a Fuel Cell Powered Wireless Network Display System with respective external fuel storage for the embedded fuel cell apparatus or external fuel cell pack with replaceable fuel cartridge or storage container according to the present invention.

FIG. 4 is a pictorial representation of a Fuel Cell Powered Wireless Network Display System with respective fuel storage container feeding the group of fuel cell apparatus in the individual wireless display according to the present invention.

FIG. 5 is a pictorial representation of a Fuel Cell Powered Wireless Network Display System with a main fuel storage container refueling the respective group fuel storage container feeding the group of fuel cell apparatus in the individual wireless display according to the present invention.

FIG. 6 is a pictorial representation of a Fuel Cell Powered Wireless Network Display System with respective fuel cell apparatus embedded in a power supply module to power a group of individual wireless display and optional power outlets or connections for other portable or equipment electronic devices according to the present invention.

FIG. 7 is a pictorial representation of a Fuel Cell Powered Wireless Network Display System with a main fuel storage container refueling the respective fuel cell apparatus embedded in a power supply module to power a group of individual wireless display and optional power outlets or connections for other portable or equipment electronic devices according to the present invention.

### DETAILED DESCRIPTION OF THE INVENTION

Referring now descriptively to the drawings, the attached figures illustrate the methods of Fuel Cell Powered Wireless Network Display Systems:

The following description of the preferred embodiment of the invention is not intended to limit the scope of the invention but rather to enable any person skilled in the art to make and use this invention.

The fuel cells described herein can be micro fuel cell types wherein they are suitable. The fuel cell or micro fuel cell may consist of power conditioning circuits to controlling the required electrical voltage, current flow, frequency, and electrical characteristics.

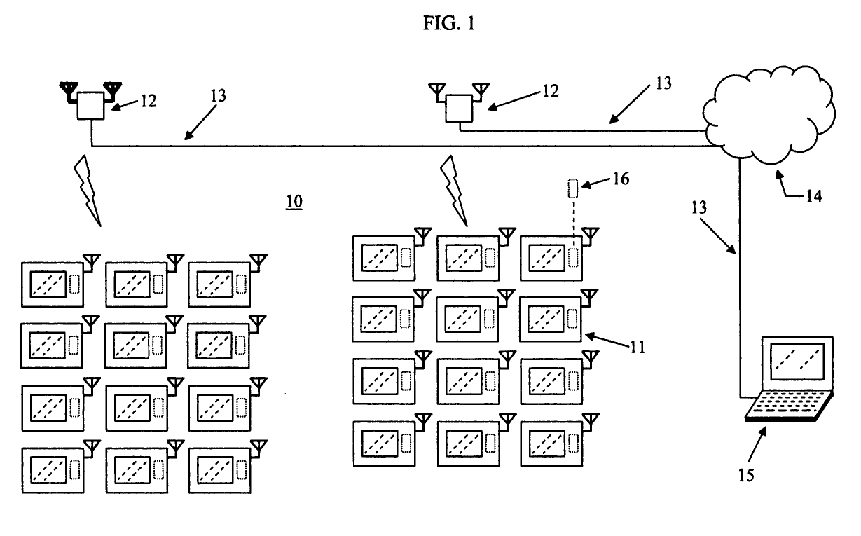

As shown in FIG. 1, the invention is a fuel cell powered wireless network display system 10, which is comprised of wireless display 11 with replaceable fuel cell pack 16 installed like “battery pack”, wireless access module 12 consists of antenna and transceiver circuitry with network wiring 13 interface. The wireless access module 12 operates in IEEE 802.11a, 802.11g, 802.11n, 802.16, ultra-wideband (UWB), Wireless USB or a wireless network using a suitable radio frequency channel or band of at least one applicable wireless standard enabling wireless delivery of digital content or data from and to at least one external digital media source 14 and at least one intended wireless display 11 in single-band or dual-band. The wireless network is scalable to enabling multiple wireless displays operating in a group or multiple groups in subnet configurations. The optional system management panel 15 consists of a computer display which is connected to the network via the Ethernet 13 or wireless link to display status of the respective fuel cell apparatus 16 in or connected to the wireless displays 11.

As shown in FIG. 1, the fuel cell powered wireless displays 11 provide digital content playback, from wireless access to the external media sources 14 or locally cached digital content storage, such as video, audio, and data by individual selection. The fuel cell powered wireless displays 11 are not required to have constant connectivity to the wireless network unless real-time content access or content refresh is desired; thus, the fuel cell powered wireless displays 11 can be fix mounted or portable.

As shown in FIG. 1, the fuel cell powered wireless displays 11 with the fuel cell pack 16 installed can be replaced like a “battery pack”. The fuel cell pack 16 has embedded or internal fuel storage.

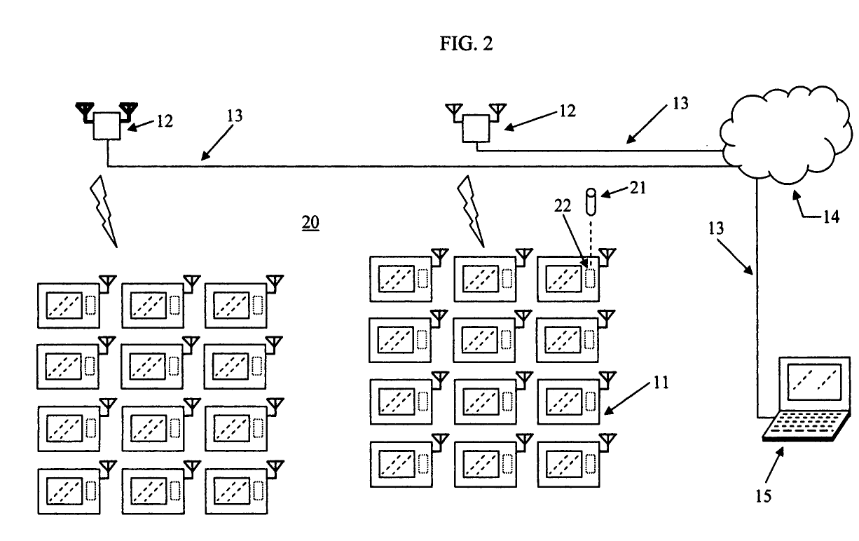

As shown in FIG. 2, another embodiment in the invention is a fuel cell powered wireless network display system 20, consists of replaceable fuel cartridge or storage container 21 for ease of refueling the embedded fuel cell apparatus 22 in each individual wireless display 11. The wireless network is the same as described in FIG. 1; thus, the fuel cell powered wireless displays 11 can be fix mounted or portable.

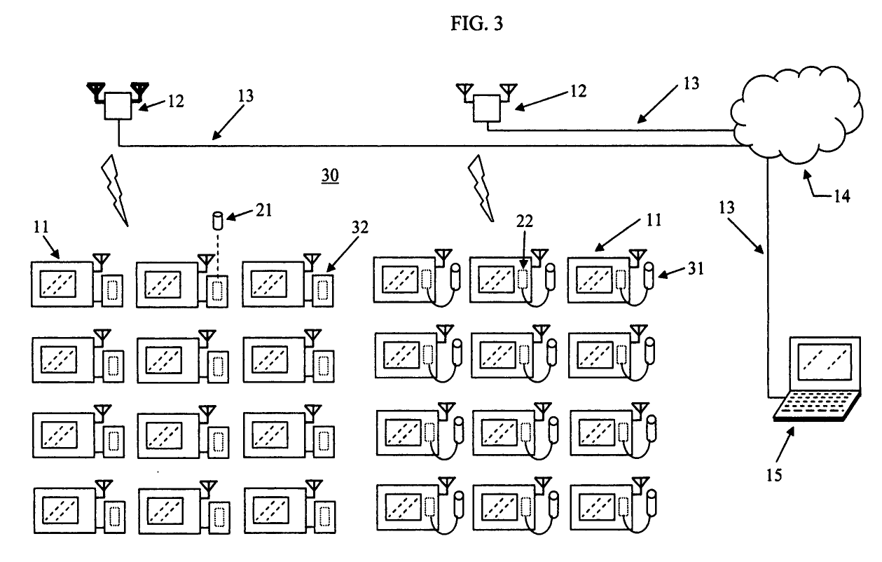

As shown in FIG. 3, another embodiment in the invention is a fuel cell powered wireless network display system 30, consists of an external fuel cartridge or storage container 31 feeding the respective fuel cell apparatus 22 embedded in each individual wireless display 11 for ease of refueling using proper hose connection. The wireless network is the same as described in FIG. 1; thus, the fuel cell powered wireless displays 11 can be fix mounted or portable.

As shown in FIG. 3, an alternate embodiment in the invention in the fuel cell powered wireless network display system 30, consists of external fuel cell pack 32 electrically connected with the respective wireless display 11. A replaceable fuel cartridge or storage container 21 feeds the external fuel cell pack 32 for ease of fuel replenishment. The wireless network is the same as described in FIG. 1; thus, the fuel cell powered wireless displays 11 can be fix mounted or portable.

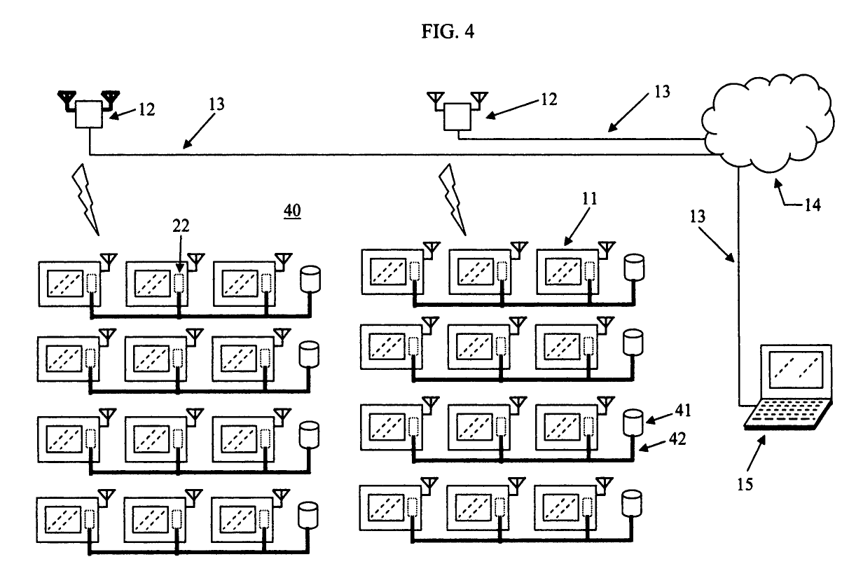

As shown in FIG. 4, another embodiment in the invention is a fuel cell powered wireless network display system 40, consists of fuel storage container 41 feeding the respective group of fuel cell apparatus 22 in the respective wireless display 11 via the proper hose connections or plumbing 42. Fuel is replenished by replacing or refilling the fuel storage container 41. The wireless network is the same as described in FIG. 1.

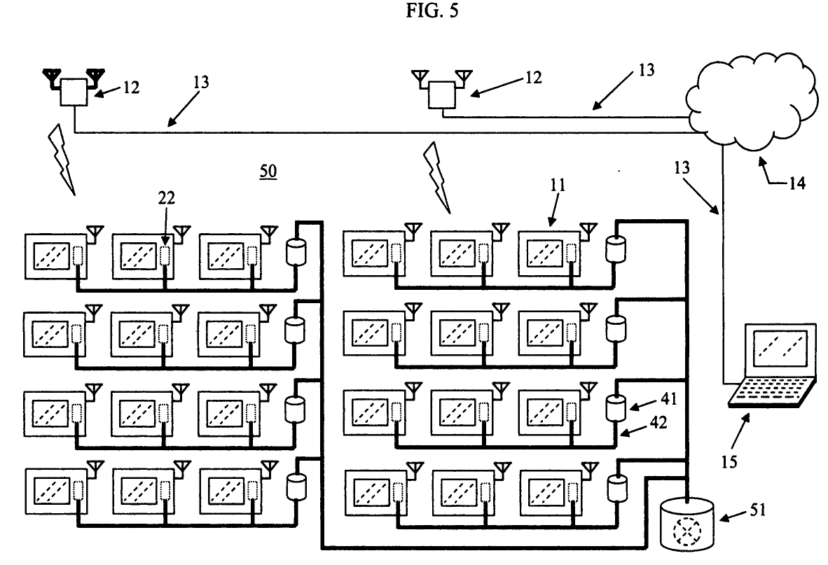

As shown in FIG. 5, another embodiment in the invention is a fuel cell powered wireless network display system 50, consists of a main fuel storage container 51 with automatic pump refueling the respective group fuel storage container 41 feeding the group of fuel cell apparatus 22 in the respective wireless display 11 via the proper hose connections or plumbing 42. Fuel is replenished by filling the fuel storage container 51. The wireless network is the same as described in FIG. 1.

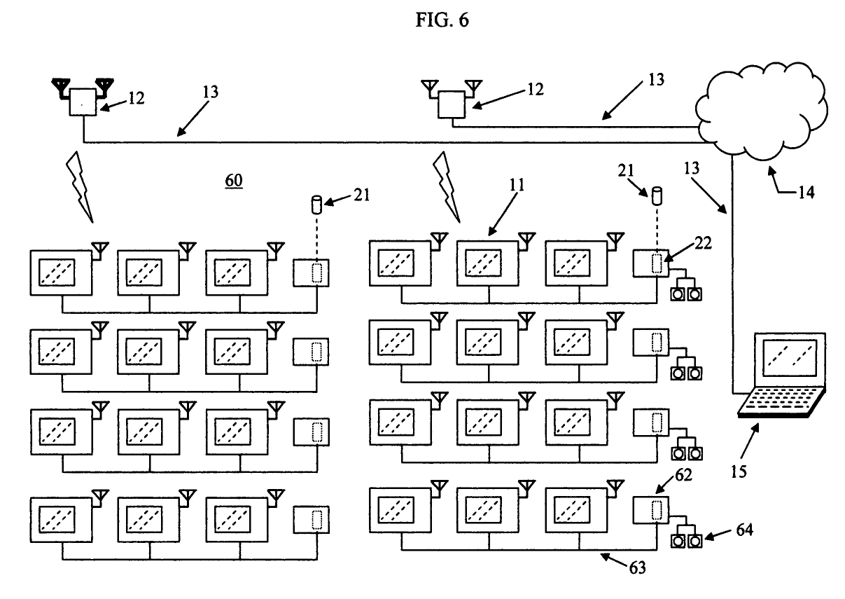

As shown in FIG. 6, another embodiment in the invention is a fuel cell powered wireless network display system 60, consists of fuel cell apparatus 22 in a power supply module 62 to power the respective group of individual wireless display 11 via proper wiring or plug-in connections 63. Fuel cartridge or fuel storage container 21 is used to replenish fuel in the power supply module 62. The power supply module 62 consists of power conditioning circuits to controlling the required electrical voltage, current flow, frequency, and electrical characteristics as well as power protection and shut-off circuits. The wireless network is the same as described in FIG. 1; thus, the fuel cell powered wireless displays 11 can be fix mounted or portable.

As shown in FIG. 6, an alternate embodiment in the invention in the fuel cell powered wireless network display system 60, consists of optional power outlets or connections 64 for powering other portable or equipment electronic devices.

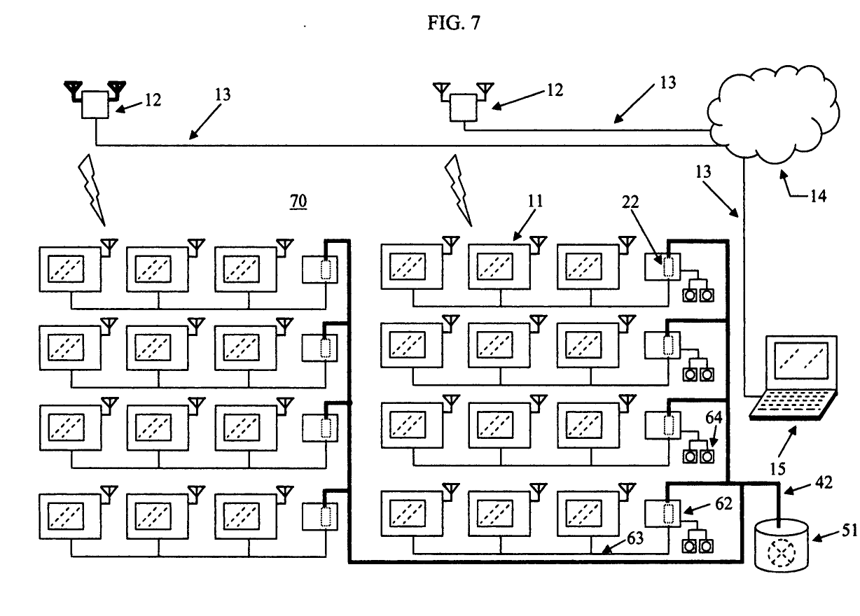

As shown in FIG. 7, another embodiment in the invention is a fuel cell powered wireless network display system 70, consists of a main fuel storage container 51 with automatic pump feeding, via proper hose connections or plumbing 42, the respective fuel cell apparatus 22 in the power supply module 62 to power the group of individual wireless display 11 via proper wiring or plug-in connections 63. Fuel is replenished by refilling the fuel storage container 51. The power supply module 62 consists of power conditioning circuits to controlling the required electrical voltage, current flow, frequency, and electrical characteristics as well as power protection and shut-off circuits. The wireless network is the same as described in FIG. 1.

As shown in FIG. 7, an alternate embodiment in the invention in the fuel cell powered wireless network display system 70, consists of optional power outlets or connections 64 for powering other portable or equipment electronic devices.

An alternate embodiment, not shown in figures, of the invention is to supply power using fuel cell as described above to Power-over-Ethernet display systems or wired network display systems wherever suitable.

Further to the descriptions of the methods in the present invention above, the types of fuel cell can be considered for the applications in the invention are, but limited to, Proton Exchange Membrane Fuel Cell, Direct Methanol Fuel Cell, Reformed Methanol Fuel Cell, Direct Ethanol Fuel Cell, Molten Carbonate Fuel Cell, Solid Oxide Fuel Cell, Phosphoric Acid Fuel Cell, Solid Polymer Fuel Cell, Alkali Fuel Cell, Hydrazine Fuel Cell, Regenerative Fuel Cell, Zinc-Air Fuel Cell, Protonic Ceramic Fuel Cell, Metal Hydride Fuel Cell, Blue Energy Fuel Cell, Electro-Galvanic Fuel Cell, Microbial Fuel Cell, Reversible Fuel Cell, Direct Borohydride Fuel Cell, Formic Acid Fuel Cell, and Direct Carbon Fuel Cell. The most practical fuel cell or micro fuel cell types for the applications are Proton Exchange Membrane Fuel Cell, Direct Methanol Fuel Cell, Reformed Methanol Fuel Cell, and Direct Ethanol Fuel Cell that use hydrocarbon based fuel such as methanol or ethanol.

The described methods in the present invention shall meet applicable regulations, certifications, and required markings for the purposes and environment that they are intended to operate. Proper heat sinking and shielding as well as power protection and shut-off are important considerations for the applications.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art that are within the scope of the present invention. Furthermore, as any person skilled in the art of fuel cell powered wireless network display systems will recognize from the previous detailed description and from the figures, modifications and changes can be made to the preferred embodiment of the invention without departing from the scope of this invention.

1. A wireless network display system comprising: at least one group of multiple fuel cell powered wireless displays for digital content playback from real time delivery or local digital storage; fuel cells or fuel cell powered power supply modules for powering the wireless displays; and at least one wireless network for constant or temporary connectivity for content access by the wireless displays.

2. The system of claim 1, wherein the fuel cells are replaceable fuel cell or micro fuel cell packs, each of which is installed inside one of the wireless displays.

3. The system of claim 1, wherein the fuel cells are individual fuel cells or micro fuel cells, each of which is embedded inside one of the wireless displays, with a replaceable fuel cartridge or a storage container for fuel replenishment.

4. The system of claim 1, wherein the fuel cells are external fuel cell or micro fuel cell packs, each of which is connected externally to power one of the wireless displays, with a replaceable fuel cartridge or a storage container for fuel replenishment.

5. The system of claim 1, wherein the fuel cells are individual fuel cells or micro fuel cells, each of which is embedded inside one of the wireless displays, where the fuel is supplied by an external fuel storage container via constant feed.

6. The system of claim 1, wherein each fuel cell powered external power supply module is an external power supply module and is embedded with a fuel cell or micro fuel cell where the fuel is supplied by a replaceable fuel cartridge or a storage container.

7. The system of claim 1, wherein each fuel cell powered external power supply module is an external power supply module and is embedded with a fuel cell or micro fuel cell where the fuel is supplied by an external fuel storage container via constant feed.

8. The system of claim 6, wherein each fuel cell or micro fuel cell powered external power supply module is capable to provide power via an electrical connection or outlet to a portable or equipment electronic device.
